(19) United States
(12) Patent Application Publication
(10) Pub. No.: US 2020/0051744 A1
(43) Pub. Date: Feb. 13, 2020

(54) MULTILAYER CERAMIC CAPACITOR AND METHOD OF MANUFACTURING THE SAME

(71) Applicant: SAMSUNG ELECTRO-MECHANICS CO., LTD., Suwon-Si (KR)

(72) Inventors: Yong Park, Suwon-Si (KR); Ki Pyo Hong, Suwon-Si (KR)

(21) Appl. No.: 16/139,956

(22) Filed: Sep. 24, 2018

(30) Foreign Application Priority Data
Aug. 9, 2018 (KR) 10-2018-0092774

(51) Int. Cl. H01G 4/30; H01G 4/008; H01G 4/12

(52) U.S. Cl. CPC H01G 4/30; H01G 4/1227; H01G 4/008

(57) ABSTRACT

A multilayer ceramic capacitor includes: a ceramic body including dielectric layers and having first and second surfaces opposing each other, third and fourth surfaces connecting the first and second surfaces, and fifth and sixth surfaces connected to the first to fourth surfaces and opposing each other; internal electrodes disposed in the ceramic body, exposed to the first and second surfaces, and each having one end exposed to the third or fourth surface; and first and second side margin portions disposed on end portions of the internal electrodes exposed to the first and second surfaces. The first side margin portion has a slope with respect to the fifth or sixth surface having the same sign at corner portions thereof, and the second side margin portion has a slope with respect to the fifth or sixth surface having the same sign at corner portions thereof.

### CROSS-REFERENCE TO RELATED APPLICATION(S)

This application claims benefit of priority to Korean Patent Application No. 10-2018-0092774 filed on Aug. 9, 2018 in the Korean Intellectual Property Office, the disclosure of which is incorporated herein by reference in its entirety.

### TECHNICAL FIELD

The present disclosure relates to a multilayer ceramic capacitor having improved reliability by forming a side margin portion to not be coated up to an upper surface of a ceramic body, and a method of manufacturing the same.

### BACKGROUND

In general, electronic components using a ceramic material, such as capacitors, inductors, piezoelectric elements, varistors, thermistors, or the like, include a ceramic body formed of a ceramic material, internal electrodes formed in the ceramic body, and external electrodes disposed on a surface of the ceramic body to be connected to the internal electrodes.

Recently, as electronic products have been reduced in size and have had multifunctionality implemented therein, electronic components have also become compact and highly functional, and thus, a multilayer ceramic capacitor which is small but has high capacitance has been demanded.

In order to allow the multilayer ceramic capacitor to have a small size and high capacitance, it is essential to significantly increase an effective area of electrodes (increase an effective volume fraction required to implement capacitance).

In order to implement the multilayer ceramic capacitor having a small size and high capacitance as described above, a method of significantly increasing an area of internal electrodes in a width direction through a margin-free design by allowing the internal electrodes to be exposed to a body in the width direction at the time of manufacturing the multilayer ceramic capacitor, and then separately attaching a side margin portion to an electrode exposed surface of a capacitor body in the width direction before sintering the capacitor body after manufacturing this capacitor body has been applied.

However, in a case in which the side margin portion is coated on an upper surface of a ceramic body, an inflection point may be generated in a corner portion of an end surface of the ceramic in a width-thickness direction to which the side margin portion is attached, and thus a burr defect may occur.

Further, in the case in which the side margin portion is coated on the upper surface of the ceramic body, a region of the side margin portion exceeding an area of the ceramic body maybe generated, such that adhesive force between a side margin sheet and the ceramic body may be decreased.

A decrease in adhesive force between the side margin sheet and the ceramic body may cause a detachment defect of the side margin sheet depending on contraction and sintering behaviors of the side margin sheet and the ceramic body during calcination and sintering.

A phenomenon in which the side margin portion is partially detached as described above causes an exterior defect, and may also cause deterioration of insulation resistance characteristics and a defect in moisture resistance reliability.

Further, this phenomenon may cause problems such as a non-uniformity problem in external electrode coating, exceeding of a size specification of a product, and an exterior defect problem.

Therefore, research into a technology capable of satisfying a standard for exterior defects without exceeding a size specification of a product by preventing a ceramic body and a side margin portion from being detached from each other in a micro-sized and high capacitance product and securing uniformity in external electrode coating has been required.

### SUMMARY

An aspect of the present disclosure may provide a multilayer ceramic capacitor having improved reliability by forming a side margin portion to not be coated up to an upper surface of a ceramic body, and a method of manufacturing the same.

According to an aspect of the present disclosure, a multilayer ceramic capacitor may include: a ceramic body including dielectric layers and having first and second surfaces opposing each other, third and fourth surfaces connecting the first and second surfaces, and fifth and sixth surfaces connected to the first to fourth surfaces and opposing each other; a plurality of internal electrodes disposed in the ceramic body, exposed to the first and second surfaces, and each having one end exposed to the third or fourth surface; and first and second side margin portions disposed on end portions of the internal electrodes exposed to the first and second surfaces. The first side margin portion may have a slope with respect to the fifth surface or the sixth surface having the same sign at corner portions at which the first surface of the ceramic body and the fifth and sixth surfaces thereof intersect each other, and the second side margin portion may have a slope with respect to the fifth surface or the sixth surface having the same sign at corner portions at which the second surface of the ceramic body and the fifth and sixth surfaces thereof intersect each other. An average thickness of each of the first and second side margin portions may be 2 μm or more to 10 μm or less.

According to another aspect of the present disclosure, a method of manufacturing a multilayer ceramic capacitor may include: preparing a first ceramic green sheet on which a plurality of first internal electrode patterns are formed with a predetermined interval therebetween and a second ceramic green sheet on which a plurality of second internal electrode patterns are formed with a predetermined interval therebetween; forming a ceramic green sheet laminate by stacking the first and second ceramic green sheets so that the first and second internal electrode patterns are alternated with each other; cutting the ceramic green sheet laminate to have side surfaces to which distal ends of the first and second internal electrode patterns are exposed in a width direction; and forming first and second side margin portions on the side surfaces of the cut ceramic green sheet laminate to which the distal ends of the first and second internal electrode patterns are exposed. An average thickness of each of the first and second side margin portions may be 2 μm or more to 10 μm or less.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic perspective view illustrating a multilayer ceramic capacitor according to an exemplary embodiment in the present disclosure;

FIG. 2 is a perspective view illustrating an exterior of a ceramic body of FIG. 1;

FIG. 3 is a perspective view of a ceramic green sheet laminate before sintering the ceramic body of FIG. 2;

FIG. 4 is a side view illustrating of the ceramic body in an A direction of FIG. 2; and

FIGS. 5A through 5F are cross-sectional views and a perspective view schematically illustrating a method of manufacturing a multilayer ceramic capacitor according to another exemplary embodiment in the present disclosure.

### DETAILED DESCRIPTION

Hereinafter, exemplary embodiments of the present disclosure will now be described in detail with reference to the accompanying drawings.

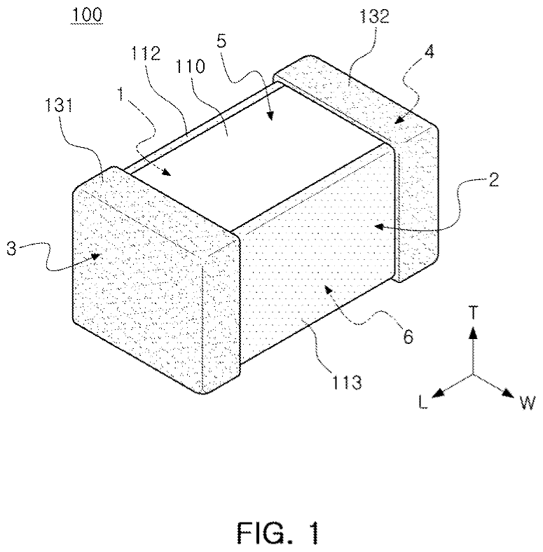

FIG. 1 is a schematic perspective view illustrating a multilayer ceramic capacitor according to an exemplary embodiment in the present disclosure.

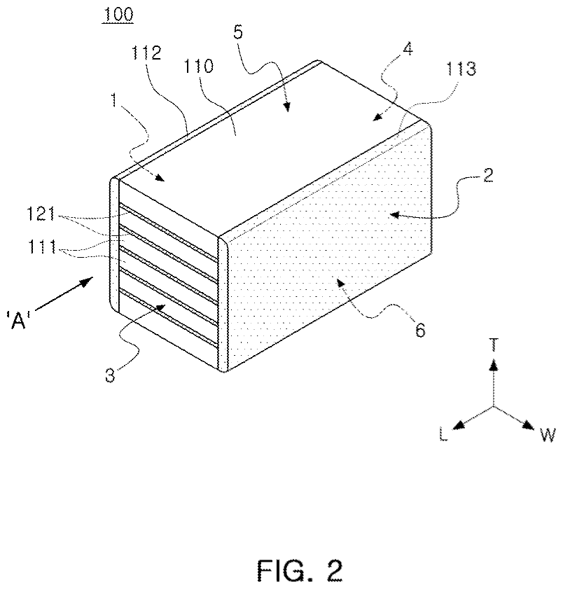

FIG. 2 is a perspective view illustrating an exterior of a ceramic body of FIG. 1.

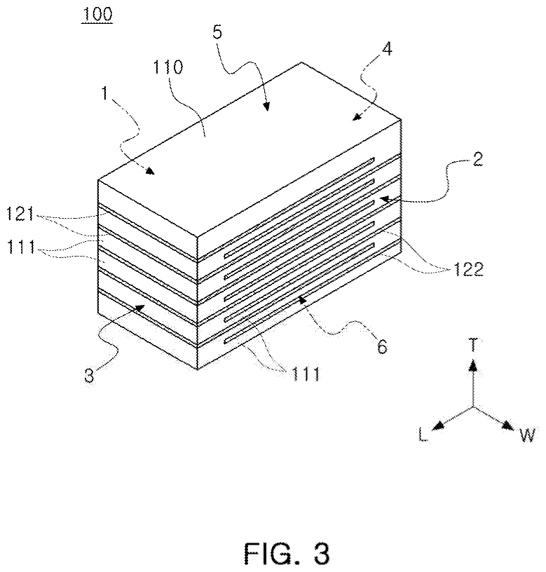

FIG. 3 is a perspective view of a ceramic green sheet laminate before sintering the ceramic body of FIG. 2.

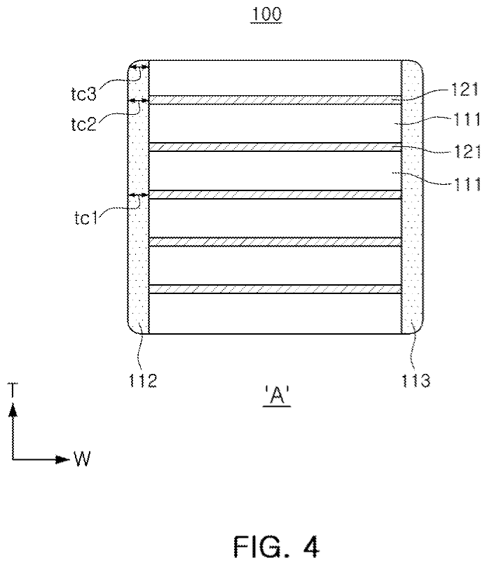

FIG. 4 is a side view illustrating of the ceramic body in an A direction of FIG. 2.

Referring to FIGS. 1 through 4, a multilayer ceramic capacitor 100 according to the present exemplary embodiment may include a ceramic body 110; a plurality of internal electrodes 121 and 122 formed in the ceramic body 110; and external electrodes 131 and 132 formed on an outer surface of the ceramic body 110.

The ceramic body 110 may have first and second surfaces 1 and 2 opposing each other, third and fourth surfaces 3 and 4 connecting the first and second surfaces to each other, and fifth and sixth surfaces 5 and 6 corresponding to upper and lower surfaces, respectively.

The first and second surfaces 1 and 2 may be defined as surfaces of the ceramic body 110 opposing each other in a width direction W, the third and fourth surfaces 3 and 4 may be defined as surfaces of the ceramic body 110 opposing each other in a length direction L, and the fifth and sixth surfaces 5 and 6 may be defined as surfaces of the ceramic body 110 opposing each other in a thickness direction T.

A shape of the ceramic body 110 is not particularly limited, but may be a rectangular parallelepiped shape as illustrated.

One ends of the plurality of internal electrodes 121 and 122 formed in the ceramic body 110 may be exposed to the third or fourth surface 3 or 4 of the ceramic body 110.

The internal electrodes 121 and 122 may be formed as a pair of first and second internal electrodes 121 and 122 having different polarities from each other.

One end of the first internal electrode 121 may be exposed to the third surface 3 and one end of the second internal electrode 122 may be exposed to the fourth surface 4.

The other ends of the first internal electrode 121 may be spaced apart from the fourth surface 4 by a predetermined interval, and the other ends of the second internal electrode 122 may be spaced apart from the third surface 3 by a predetermined interval.

The first and second external electrodes 131 and 132 may be formed on the third and fourth surfaces 3 and 4 of the ceramic body 110 to be electrically connected to the internal electrodes.

The multilayer ceramic capacitor 100 according to the exemplary embodiment in the present disclosure may include the plurality of internal electrodes 121 and 122 disposed in the ceramic body 110, exposed to the first and second surfaces 1 and 2, and each having one end exposed to the third or fourth surface 3 or 4, and first and second side margin portions 112 and 113 disposed on end portions of the first and second internal electrodes 121 and 122 exposed to the first and second surfaces 1 and 2, respectively.

The plurality of internal electrodes 121 and 122 may be formed in the ceramic body 110, a distal end of each of the plurality of internal electrodes 121 and 122 may be exposed to the first and second surfaces 1 and 2, the surfaces of the ceramic body 110 in the width direction, and the first and second side margin portions 112 and 113 may be disposed on the exposed end portions, respectively.

An average thickness of each of the first and second side margin portions 112 and 113 may be 2 μm or more to 10 μm or less. The average thickness of a side margin portion may be measured from an image obtained by scanning a cross section of the ceramic body 110 in the thickness direction using a scanning electron microscope (SEM). For example, a thickness at the predetermined number of points, for example, thirty points, that are equidistant from each other in the thickness direction may be measured from the image obtained by scanning a cross-section of the ceramic body 110 in a width-thickness (W-T) direction taken along a central portion of the ceramic body 110 in the length (L) direction using the scanning electron microscope (SEM), thereby determining the average thickness of a side margin portion by dividing a sum of thicknesses measured at the predetermined number of points by the predetermined number.

According to the exemplary embodiment in the present disclosure, the ceramic body 110 may include a laminate in which a plurality of dielectric layers 111 are stacked and the first and second side margin portions 112 and 113 disposed on both side surfaces of the laminate.

The plurality of dielectric layers 111 may be in a sintered state and adjacent dielectric layers maybe integrated with each other so that boundaries therebetween are not readily apparent.

A length of the ceramic body 110 may correspond to a distance from the third surface 3 of the ceramic body 110 to the fourth surface 4 thereof.

A length of the dielectric layer 111 may correspond to the distance between the third and fourth surfaces 3 and 4 of the ceramic body 110.

According to the exemplary embodiment in the present disclosure, the length of the ceramic body 110 may be 400 to 1400 μm, but is not limited thereto. In more detail, the length of the ceramic body 110 may be 400 to 800 μm or 600 to 1400 μm.

The internal electrodes 121 and 122 may be formed on the dielectric layers 111 and be formed in the ceramic body 110 with each of the dielectric layers interposed therebetween by sintering.

Referring to FIG. 3, the first internal electrode 121 may be formed on the dielectric layer 111. The first internal electrode 121 may not be entirely formed in a length direction of the dielectric layer. That is, one end of the first internal electrode 121 may be formed to have a predetermined interval from the fourth surface 4 of the ceramic body 110, and the other end of the first internal electrode 121 may be formed up to the third surface 3 of the ceramic body 110 to be exposed to the third surface 3 of the ceramic body 110.

An end portion of the first internal electrode exposed to the third surface 3 of the laminate may be connected to the first external electrode 131.

Differently from the first internal electrode, one end of the second internal electrode 122 may be formed to have a predetermined interval from the third surface 3, and the other end of the second internal electrode 122 may be exposed to the fourth surface 4 to thereby be connected to the second external electrode 132.

In order to implement a high-capacitance multilayer ceramic capacitor, the number of stacked internal electrode layers may be 400 or more, but is not necessarily limited thereto.

The dielectric layer 111 may have the same width as that of the first internal electrode 121. That is, the first internal electrode 121 may be entirely formed on the dielectric layer 111 in a width direction of the dielectric layer 111. The dielectric layer 111 may have the same width as that of the second internal electrode 122. That is, the second internal electrode 122 may be entirely formed on the dielectric layer 111 in the width direction of the dielectric layer 111.

According to the exemplary embodiment in the present disclosure, the width of the dielectric layer and the width of the internal electrode may be 100 to 900 μm, but are not limited thereto. In more detail, the width of the dielectric layer and the width of the internal electrode may be 100 to 500 μm or 100 to 900 μm.

As the ceramic body becomes miniaturized, a thickness of the side margin portion may have an influence on electrical characteristics of the multilayer ceramic capacitor. According to the exemplary embodiment in the present disclosure, the side margin portion may be formed to have a thickness of 10 μm or less, thereby improving characteristics of a miniaturized multilayer ceramic capacitor.

That is, as the side margin portion may be formed to have a thickness of 10 μm or less, an overlapping area between the internal electrodes forming capacitance may be secured as much as possible, such that a multilayer ceramic capacitor having high capacitance and a small size may be implemented.

The ceramic body 110 as described above may include an active portion as a portion contributing to forming capacitance of the capacitor and upper and lower cover portions formed on upper and lower surfaces of the active portion, respectively.

The active portion may be formed by repeatedly stacking the plurality of first and second internal electrodes 121 and 122 with each of the dielectric layers 111 interposed therebetween.

The upper and lower cover portions may have the same material and configuration as those of the dielectric layer 111 except that the internal electrodes are not included therein.

That is, the upper and lower cover portions may contain a ceramic material, for example, a barium titanate (BaTiO₃) based ceramic material.

Each of the upper and lower cover portions may have a thickness of 20 μm or less, but is not necessarily limited thereto.

In the exemplary embodiment in the present disclosure, the internal electrode and the dielectric layer may be formed by being simultaneously cut, such that the width of the internal electrode may be equal to that of the dielectric layer. Amore detailed description thereof will be described below.

In the present exemplary embodiment, the dielectric layer may be formed to have the same width as that of the internal electrode, such that the distal ends of the internal electrodes 121 and 122 may be exposed to the first and second surfaces of the ceramic body 110 in the width direction.

The first and second side margin portions 112 and 113 may be formed on both side surfaces of the ceramic body 110 in the width direction, to which the distal ends of the internal electrodes 121 and 122 are exposed.

The thickness of the first and second side margin portions 112 and 113 may be 10 μm or less. The thinner the thickness of the first and second side margin portions 112 and 113, the wider the area of an overlapping region between the internal electrodes formed in the ceramic body 110.

The thickness of the first and second side margin portions 112 and 113 is not limited as long as short-circuit of the internal electrodes exposed to the side surface of the ceramic body 110 may be prevented. For example, the thickness of the first and second side margin portions 112 and 113 may be 2 μm or more.

When the thickness of the first and second side margin portions is less than 2 μm, mechanical strength against external impact may be deteriorated, and when the thickness of the first and second side margin portions is more than 10 m, the area of the overlapping region between the internal electrodes may be relatively decreased, such that it may be difficult to secure high capacitance of the multilayer ceramic capacitor.

In order to significantly increase capacitance of a multilayer ceramic capacitor, a method of thinning the dielectric layer, a method of highly stacking thinned dielectric layers, a method of increasing a coverage of the internal electrode, and the like, have been considered.

Further, a method of increasing an area of an overlapping region between internal electrodes forming capacitance has been considered.

In order to increase the area of the overlapping region between the internal electrodes, there is a need to significantly decrease a region of a margin portion in which the internal electrode is not formed.

In particular, as the multilayer ceramic capacitor becomes miniaturized, the region of the margin portion needs to be significantly decreased in order to increase the overlapping region between the internal electrodes.

According to the present exemplary embodiment, the internal electrode may be formed on the entire dielectric layer in the width direction and the thickness of the side margin portion may be set to be 10 μm or less, such that the area of the overlapping region between the internal electrodes may become wide.

Generally, as the dielectric layer is highly stacked, thicknesses of the dielectric layer and the internal electrode may be decreased. Therefore, the phenomenon in which the internal electrodes are short-circuited may frequently occur. In addition, when the internal electrode is formed only on a portion of the dielectric layer, an accelerated lifespan or reliability of insulating resistance may be deteriorated due to a step by the internal electrode.

However, according to the present exemplary embodiment, even though thin internal electrodes and thin dielectric layers are formed, since the internal electrode is entirely formed on the dielectric layer in the width direction, the area of the overlapping region between the internal electrodes may be increased, thereby increasing the capacitance of the multilayer ceramic capacitor.

In addition, an accelerated lifespan of insulating resistance may be improved by decreasing the step by the internal electrode, such that a multilayer ceramic capacitor having excellent capacitance characteristics and reliability may be provided.

According to the exemplary embodiment in the present disclosure, the first margin portion 112 may have a slope with respect to the fifth surface 5 or the sixth surface 6 having the same sign at corner portions at which the first surface 1 of the ceramic body 110 and the fifth and sixth surfaces 5 and 6 thereof intersect each other, and the second side margin portion 113 may have a slope with respect to the fifth surface 5 or the sixth surface 6 having the same sign at corner portions at which the second surface 2 of the ceramic body 110 and the fifth and sixth surfaces 5 and 6 thereof intersect each other.

The first and second side margin portions 112 and 113 have a slope of the same sign, meaning that the first and second side margin portions 112 and 113 may have a round shape at corner portions of end surfaces of the ceramic body 110 in a width-thickness direction to thereby have the same slope as each other.

More specifically, this means that round portions of the first and second side margin portions 112 and 113 at the corner portions of the end surfaces of the ceramic body 110 in the width-thickness direction have the same slope and do not have an inflection point.

In another aspect, the first side margin portion 112 may be disposed so as not to exceed points at which the third surface 3 of the ceramic body 110 intersects the fifth and sixth surfaces 5 and 6 thereof, respectively, and the second side margin portion 113 may be disposed so as not to exceed points at which the fourth surface 4 of the ceramic body 110 intersects the fifth and sixth surfaces 5 and 6 thereof, respectively.

In another aspect, the first side margin portion 112 may not extend above the fifth and sixth surfaces of the ceramic body 110, and the second side margin portion 113 may not extend above the fifth and sixth surfaces of the ceramic body 110.

Generally, in a case in which a side margin portion is coated up to upper and lower surfaces of a ceramic body, an inflection point may be generated in a corner portion of an end surface of the ceramic body in a width-thickness direction to which the side margin portion is attached, and thus a burr defect may occur.

Further, in the case in which the side margin portion is coated on the upper and lower surfaces of the ceramic body, a region of the side margin portion exceeding an area of the ceramic body may be generated, such that adhesive force between a side margin sheet and the ceramic body may be decreased.

A decrease in adhesive force between the side margin sheet and the ceramic body may cause a detachment defect of the side margin sheet depending on contraction and sintering behaviors of the side margin sheet and the ceramic body during calcination and sintering.

A phenomenon in which the side margin portion is partially detached as described above causes an exterior defect, and may also cause deterioration of insulation resistance characteristics and a defect in moisture resistance reliability.

Further, this phenomenon may cause problems such as non-uniform application of external electrodes, exceeding of a size specification of a product, and an exterior defect problem.

According to the exemplary embodiment in the present disclosure, since the first and second side margin portions 112 and 113 have a slope of the same sign at the corner portions at which the first and second surfaces 1 and 2 of the ceramic body 110 and the fifth and sixth surfaces 5 and 6 thereof intersect each other, the burr defect may be prevented by allowing the first and second side margin portions 112 and 113 not to be coated up to the upper and lower surfaces of the ceramic body 110.

Further, insulation resistance may be increased and moisture resistance reliability may be improved by increasing interfacial adhesive force between the ceramic body and the side margin portions.

Further, a size specification of a product may be satisfied and an exterior defect may be prevented by preventing external electrodes from being non-uniformly coated.

The multilayer ceramic capacitor according to the exemplary embodiment in the present disclosure may be a small-sized multilayer ceramic capacitor in which a thickness of the dielectric layer 111 may be 0.4 μm or less, and a thickness of the first and second internal electrodes 121 and 122 is 0.4 μm or less.

In a case of using thin dielectric layers and thin internal electrodes as in the exemplary embodiment in the present disclosure in which the thickness of the dielectric layer 111 is 0.4 μm or less and the thickness of the first and second internal electrodes 121 and 122 is 0.4 μm or less, when side margin portions are coated on upper and lower surfaces of a ceramic body, problems such as an exterior defect, for example, a burr defect, or the like, a decrease in adhesive force between the side margin portion and the ceramic body, and non-uniform coating of external electrodes may occur.

However, in a structure in which the first and second side margin portions 112 and 113 may have a slope of the same sign at the corner portions at which the first and second surfaces 1 and 2 of the ceramic body 110 and the fifth and sixth surfaces 5 and 6 thereof intersect each other, respectively as in the exemplary embodiment in the present disclosure, reliability of a small-sized multilayer ceramic capacitor with thin layers in which the thickness of the dielectric layer 111 is 0.4 μm or less and the thickness of the internal electrodes 121 and 122 is 0.4 μm or less may be improved.

Referring to FIG. 4, a ratio of a thickness tc2 of a region of the first or second side margin portion coming in contact with a distal end of an internal electrode disposed in an outermost portion of the ceramic body 110 to a thickness tc1 of a region of the first or second side margin portion coming in contact with a distal end of an internal electrode disposed in a central portion of the ceramic body 110 among the plurality of internal electrodes 121 and 122 may be 1.0 or less.

A lower limit value of the ratio of the thickness tc2 of the region of the first or second side margin portion coming in contact with the distal end of the internal electrode disposed in the outermost portion of the ceramic body 110 to the thickness tc1 of the region of the first or second side margin portion coming in contact with the distal end of the internal electrode disposed in the central portion of the ceramic body 110 is not particularly limited, but may be preferably 0.9 or more.

According to the exemplary embodiment in the present disclosure, since the first or second margin portion is formed by attaching a ceramic green sheet to the side surface of the ceramic body unlike the relate art, the thickness of the first or second side margin portion depending on a position is uniform.

That is, according to the related art, since a side margin portion is formed by applying or printing ceramic slurry, a deviation in thickness (i.e., a difference in a maximum thickness of the side margin portion and a minimum thickness of the side margin portion) of the side margin portion depending on a position is large.

In detail, according to the related art, a thickness of a region of first or second side margin portion coming in contact with a distal end of an internal electrode disposed in a central portion of a ceramic body is formed to be thicker than that of other regions.

For example, according to the related art, a ratio of a thickness of a region of the first or second side margin portion coming in contact with a distal end of an internal electrode disposed in an outermost portion of the ceramic body to the thickness of the region of the first or second side margin portion coming in contact with the distal end of the internal electrode disposed in the central portion of the ceramic body 110 is less than 0.9, such that the deviation in thickness is large.

In a case in which the deviation in thickness of the side margin portion depending on the position is large as described above, since in a multilayer ceramic capacitor having the same size, a portion occupied by the side margin portion is large, a large size of a capacitance forming portion may not be secured, such that there may be a difficulty in securing high capacitance.

On the contrary, in the exemplary embodiment in the present disclosure, since an average thickness of the first and second side margin portions 112 and 113 is 2 μm or more to 10 μm or less and the ratio of the thickness tc2 of the region of the first or second side margin portion coming in contact with the distal end of the internal electrode disposed in the outermost portion of the ceramic body 110 to the thickness tc1 of the region of the first or second side margin portion coming in contact with the distal end of the internal electrode disposed in the central portion of the ceramic body 110 is 0.9 or more to 1.0 or less, the thickness of the side margin portions may be thin and the deviation in thickness (i.e., a difference between a maximum thickness of the side margin portion and a minimum thickness of the side margin portion) may be small, such that a large size of the capacitance forming portion may be secured.

Therefore, a high-capacitance multilayer ceramic capacitor may be implemented.

Meanwhile, referring to FIG. 4, a ratio of a thickness tc3 of a region of the first or second side margin portion coming in contact with a corner of the ceramic body 110 to a thickness tc1 of the region of the first or second side margin portion coming in contact with the distal end of the internal electrode disposed in the central portion of the ceramic body 110 among the plurality of internal electrodes 121 and 122 may be 1.0 or less.

A lower limit value of the ratio of the thickness tc3 of the region of the first or second side margin portion coming in contact with the corner of the ceramic body 110 to the thickness tc1 of the region of the first or second side margin portion coming in contact with the distal end of the internal electrode disposed in the central portion of the ceramic body 110 may be preferably 0.9 or more.

Due to the above-mentioned features, the deviation in thickness of the side margin portion depending on the region may be small, such that a large size of the capacitance forming portion may be secured, thereby making it possible to implement a high capacitance multilayer ceramic capacitor.

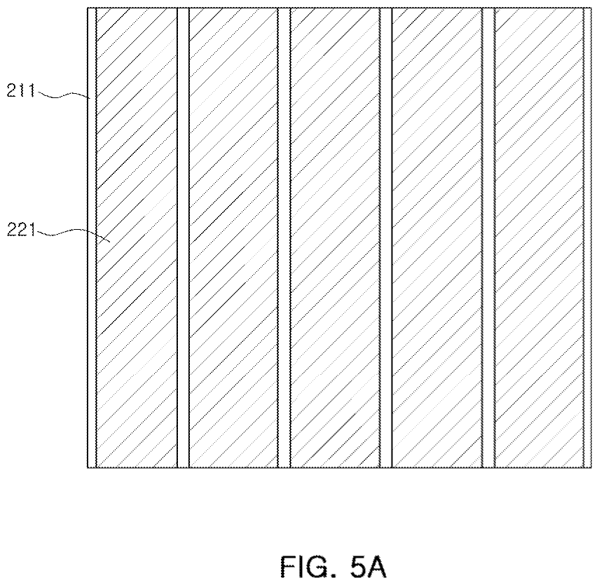

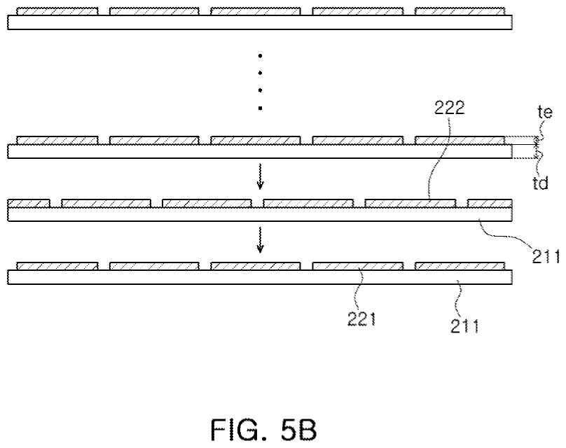

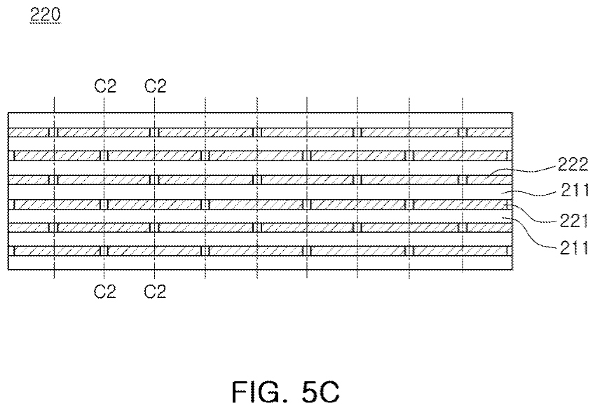

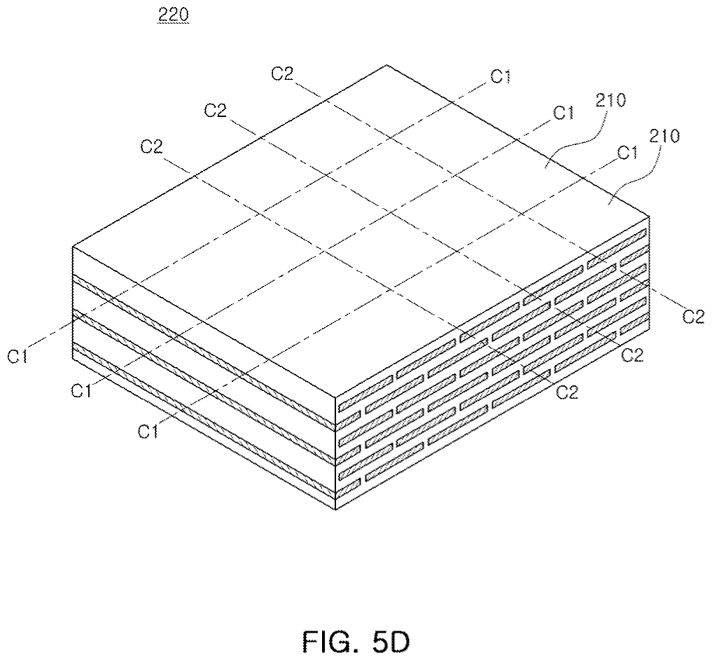

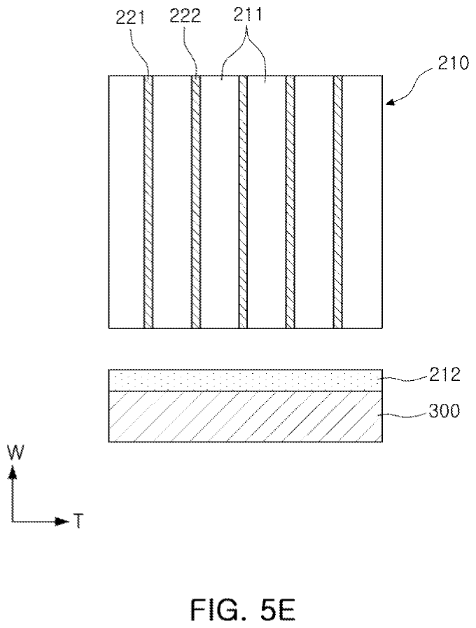

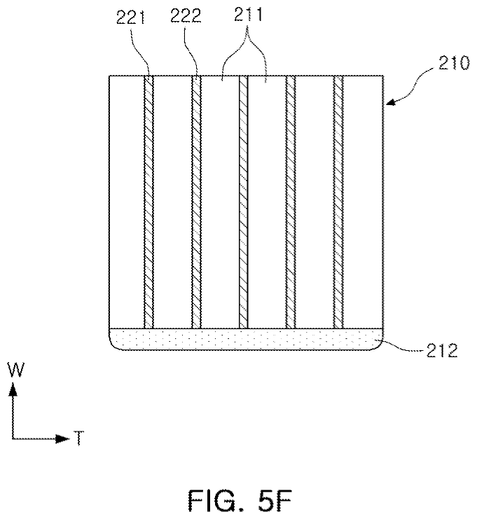

FIGS. 5A through 5F are cross-sectional views and a perspective view schematically illustrating a method of manufacturing a multilayer ceramic capacitor according to another exemplary embodiment in the present disclosure.

According to another exemplary embodiment in the present disclosure, there is provided a method of manufacturing a multilayer ceramic capacitor including: preparing a first ceramic green sheet on which a plurality of first internal electrode patterns are formed with a predetermined interval therebetween and a second ceramic green sheet on which a plurality of second internal electrode patterns are formed with a predetermined interval therebetween, forming a ceramic green sheet laminate by stacking the first and second ceramic green sheets so that the first and second internal electrode patterns are alternated with each other, cutting the ceramic green sheet laminate to have side surfaces to which distal ends of the first and second internal electrode patterns are exposed in a width direction, and forming first and second side margin portions by attaching side surface ceramic sheets onto the side surfaces of the cut ceramic green sheet laminate to which the distal ends of the first and second internal electrode patterns are exposed. A thickness of the first and second ceramic green sheets may be 0.6 μm or less, and a thickness of the first and second internal electrode patterns may be 0.5 μm or less.

Hereinafter, a method of manufacturing a multilayer ceramic capacitor according to another exemplary embodiment in the present disclosure will be described.

As illustrated in FIG. 5A, a plurality of stripe-type first internal electrode patterns 221 may be formed with a predetermined interval therebetween on a ceramic green sheet 211. The plurality of stripe-type first internal electrode patterns 221 may be formed in parallel with each other.

The ceramic green sheet 211 may be formed of a ceramic paste containing a ceramic powder, an organic solvent, and an organic binder.

The ceramic powder may be a material having high permittivity, and a barium titanate (BaTiO₃)-based material, a lead complex perovskite-based material, strontium titanate (SrTiO₃)-based material, or the like, may be used, but the ceramic powder is not limited thereto. Among them, barium titanate (BaTiO₃) powder may be preferable. When the ceramic green sheet 211 is sintered, the sintered ceramic green sheet 211 may become a dielectric layer 111 configuring a ceramic body 110.

The stripe-type first internal electrode pattern 221 may be formed of an internal electrode paste containing a conductive metal. The conductive metal may be nickel (Ni), copper (Cu), palladium (Pd), or an alloy thereof, but is not limited thereto.

A method of forming the stripe-type first internal electrode pattern 221 on the ceramic green sheet 211 is not particularly limited. For example, a printing method such as a screen printing method or a gravure printing method may be used.

Further, although not illustrated, a plurality of stripe-type second internal electrode patterns 222 may be formed with a predetermined interval therebetween on another ceramic green sheet 211.

Hereinafter, the ceramic green sheet on which the first internal electrode pattern 221 is formed may be referred to as a first ceramic green sheet, and the ceramic green sheet on which the second internal electrode pattern 222 is formed may be referred to as a second ceramic green sheet.

Next, as illustrated in FIG. 5B, the first and second ceramic green sheets may be alternately stacked so that the stripe-type first internal electrode pattern 221 and the stripe-type second internal electrode pattern 222 are alternately stacked.

Thereafter, the stripe-type first internal electrode pattern 221 may form a first internal electrode 121 and the stripe-type second internal electrode pattern 222 may form a second internal electrode 122.

According to another exemplary embodiment in the present disclosure, a thickness td of the first and second ceramic green sheets 211 may be 0.6 μm or less, and a thickness to of the first and second internal electrode patterns 221 and 222 may be 0.5 μm or less.

Since the multilayer ceramic capacitor according to the present disclosure may be a micro-sized high capacitance multilayer ceramic capacitor with thin layers in which a thickness of dielectric layers is 0.4 μm or less and a thickness of internal electrodes is 0.4 μm or less, the thickness td of the first and second ceramic green sheets may be 0.6 μm or less, and the thickness te of the first and second internal electrode patterns may be 0.5 μm or less.

According to another exemplary embodiment in the present disclosure, since first and second side margin portions have a slope of the same sign at corner portions at which first and second surfaces of a laminate 210 and fifth and sixth surfaces thereof intersect each other, respectively, as described below, reliability of a small-sized multilayer ceramic capacitor with thin layers in which the thickness td of the first and second ceramic green sheets is 0.6 μm or less and the thickness te of the first and second internal electrode patterns is 0.5 μm or less may be improved.

When the side margin portions are coated on the upper and lower surfaces of the ceramic body as in the related art, problems, for example, an exterior defect such as a burr defect, a decrease in adhesive force between the side margin portion and the ceramic body, and non-uniform coating of external electrodes may occur, but in the present disclosure, the side margin portions may not be coated on the upper and lower surfaces of the ceramic body.

Therefore, there is no exterior defect caused by delamination of the side margin portion, insulation resistance may be increased, and moisture resistance reliability may be improved.

That is, even in a case of the thin layers in which the thickness td of the first and second ceramic green sheets is 0.6 μm or less, and the thickness to of the first and second internal electrode patterns is 0.5 μm or less, electrical properties may be excellent, and reliability may be improved.

Further, the size specification of the product may be satisfied and the exterior defect may be prevented by preventing the external electrodes from being non-uniformly coated.

FIG. 5C is a cross-sectional view illustrating a ceramic green sheet laminate 220 in which the first and second ceramic green sheets are stacked according to the exemplary embodiment in the present disclosure, and FIG. 5D is a perspective view illustrating the ceramic green sheet laminate 220 in which the first and second ceramic green sheets are stacked.

Referring to FIGS. 5C and 5D, the first ceramic green sheet 211 on which the plurality of stripe-type first internal electrode patterns 221 are printed in parallel and the second ceramic green sheet 211 on which the plurality of stripe-type second internal electrode patterns 222 are printed in parallel may be alternately stacked.

In more detail, the first and second ceramic green sheets 211 may be stacked so that central portions of the stripe-type first internal electrode patterns 221 printed on the first ceramic green sheet 211 and the intervals between the stripe-type second internal electrode patterns 222 printed on the second ceramic green sheet 211 overlap each other.

Next, as illustrated in FIG. 5D, the ceramic green sheet laminate 220 may be cut so as to traverse the plurality of stripe-type first internal electrode patterns 221 and the plurality of stripe-type second internal electrode patterns 222. That is, the ceramic green sheet laminate 220 may be cut into laminates 210 along cutting lines C1-C1 and C2-C2 orthogonal to each other.

In more detail, the stripe-type first internal electrode pattern 221 and the stripe-type second internal electrode pattern 222 may be cut in a length direction to be divided into a plurality of internal electrodes having a predetermined width. In this case, the stacked ceramic green sheets may be also cut together with the internal electrode patterns. As a result, the dielectric layer may be formed to have the same width as that of the internal electrode.

Further, the ceramic green sheet laminate may be cut along the cutting line C2-C2 so as to meet a size of an individual ceramic body. That is, a plurality of laminates 210 may be formed by cutting a bar type laminate along the cutting line C2-C2 so as to be meet the size of individual ceramic body before forming first and second side margin portions.

That is, the bar-type laminate may be cut so that a central portion of overlapped first internal electrode and a predetermined interval formed between the second internal electrodes are cut along the same cutting line. Therefore, one ends of the first and second internal electrodes may be alternately exposed to a cutting surface.

Thereafter, first and second side margin portions may be formed on first and second side surfaces of the laminate 210, respectively.

Next, as illustrated in FIG. 5E, a first side margin portion 212 and a second side margin portion (not illustrated) may be formed on the first and second side surfaces of the laminate 210, respectively.

More specifically, as a method of forming the first side margin portion 212, a ceramic green sheet 212 for a side surface may be disposed on an upper portion of a punching elastic material 300 formed of rubber.

Next, after rotating the laminate 210 at an angle of 90 degrees so that the first side surface of the laminate body 210 faces the ceramic green sheet 212 for a side surface, the laminate 210 may be pressed and closely attached to the ceramic green sheet 212 for a side surface.

In a case of transferring the side surface ceramic green sheet 212 to the laminate 210 by pressurizing and closely attaching the laminate 210 to the side surface ceramic green sheet 212, the side surface ceramic green sheet 212 may be formed up to a corner portion of the side surface of the laminate 210 due to the punching elastic material 300 formed of rubber, and the other portions of the side surface ceramic green sheet 212 may be cut.

FIG. 5F illustrates the side ceramic green sheet 212 formed up to the corner portion of the side surface of the laminate 210.

That is, the first and second side margin portions may have a slope with the same sign at the corner portions at which the first and second surfaces of the laminate 210 and the fifth and sixth surfaces thereof intersect each other, respectively.

Thereafter, the second side margin portion may be formed on the second surface of the laminate 210 by rotating the laminate 210.

Next, a ceramic body may be formed by calcining and sintering the laminate 210 having both side surfaces on which the first and second side margin portions are formed.

The first side margin portion may be disposed so as not to exceed points at which a third surface of the ceramic body intersects the fifth and sixth surfaces thereof, respectively, and the second side margin portion may be disposed so as not to exceed points at which a fourth surface of the ceramic body intersects the fifth and sixth surfaces thereof, respectively.

In another aspect, the first side margin portion may not extend above the fifth and sixth surfaces of the ceramic body, and the second side margin portion may not extend above the fifth and sixth surfaces of the ceramic body.

Thereafter, external electrodes may be formed on a third side surface of the ceramic body to which the first internal electrode is exposed and a fourth side surface of the ceramic body to which the second internal electrode is exposed, respectively.

According to another exemplary embodiment in the present disclosure, since the side surface ceramic green sheet is thin and a deviation in thickness is small, a large size of a capacitance forming portion may be secured.

More specifically, since an average thickness of the first and second side margin portions 112 and 113 after the sintering is 2 μm or more to 10 μm or less and the deviation in thickness depending on a position is small, a large size of the capacitance forming portion may be secured.

Therefore, a high-capacitance multilayer ceramic capacitor may be implemented.

A description of the same features as those in the exemplary embodiment in the present disclosure described above will be omitted in order to avoid an overlapping description.

Hereinafter, the present disclosure will be described in detail through Experimental Examples, but the Experimental Examples are to help the specific understanding of the present disclosure. Therefore, the scope of the present disclosure is not limited thereto.

### EXPERIMENTAL EXAMPLE

According to the exemplary embodiment in the present disclosure, side margin portions according to the related art were formed in Comparative Example, and side margin portion were not formed on upper and lower surfaces of a ceramic body in Inventive Example.

Further, ceramic green sheet laminates were formed by attaching side surface ceramic green sheets to electrode exposed portions of green chips to which internal electrodes were exposed without a margin in a width direction as in Comparative Example and Inventive Example, respectively.

The side surface ceramic green sheets were attached to both surfaces of each of the ceramic green sheet laminates by applying a predetermined temperature and pressure under the conditions at which deformation of the chip may be minimized, thereby manufacturing a multilayer ceramic capacitor green chip having a 0603 size (length×width×height: 0.6 mm×0.3 mm×0.3 mm).

A multilayer ceramic capacitor sample manufactured as described above was subjected to calcination at 400° C. or less under a nitrogen atmosphere and then sintered under the conditions of a sintering temperature of 1200° C. or less and a hydrogen (H₂) concentration of 0.5% or less. Then, an exterior defect and electrical properties such as insulation resistance and moisture resistance were comprehensively confirmed.

In Comparative Example in which the side margin portion was coated on upper and lower surfaces of the ceramic body, an exterior defect occurred due to a burr defect, and problems such as a decrease in insulation resistance and deterioration of moisture resistance occurred due to a decrease in adhesive force between the side margin portion and the ceramic body.

However, in an Inventive Example in which the side margin portion was not coated on the upper and lower surfaces of the ceramic body, there was no burr defect, adhesive force between the side margin portion and the ceramic body was excellent, there was no delamination defect, insulation resistance was excellent, and moisture resistance reliability was improved.

As set forth above, according to exemplary embodiments in the present disclosure, the burr defect may be prevented by separately attaching the first and second side margin portions and allowing the first and second side portions not to be coated up to the upper surface of the ceramic body after entirely forming the internal electrode in the width direction of the dielectric layer to be exposed to the side surfaces of the ceramic body in the width direction.

Further, insulation resistance may be increased and moisture resistance reliability may be improved by increasing interfacial adhesive force between the ceramic body and the side margin portion.

In addition, the size specification of the product may be satisfied and the exterior defect may be prevented by preventing external electrodes from being non-uniformly coated.

While exemplary embodiments have been shown and described above, it will be apparent to those skilled in the art that modifications and variations could be made without departing from the scope of the present invention as defined by the appended claims.

1. A multilayer ceramic capacitor comprising:
a ceramic body including dielectric layers and having first and second surfaces opposing each other, third and fourth surfaces connecting the first and second surfaces, and fifth and sixth surfaces connected to the first to fourth surfaces and opposing each other;
a plurality of internal electrodes disposed in the ceramic body, exposed to the first and second surfaces, and each having one end exposed to the third or fourth surface;
first and second side margin portions disposed on the end portions of the internal electrodes exposed to the first and second surfaces;
a first external electrode disposed on the third surface of the ceramic body and covering respective first portions of the first, second, fifth, and sixth surfaces; and
a second external electrode disposed on the fourth surface of the ceramic body and covering respective second portions of the first, second, fifth, and sixth surfaces,
wherein the first side margin portion has a slope with respect to the fifth surface or the sixth surface having the same sign at corner portions at which the first surface of the ceramic body and the fifth and sixth surfaces thereof intersect each other, and the second side margin portion has a slope with respect to the fifth surface or the sixth surface having the same sign at corner portions at which the second surface of the ceramic body and the fifth and sixth surfaces thereof intersect each other,
an average thickness of each of the first and second side margin portions is 2 μm or more to 10 μm or less,
a ratio of a thickness of a region of the first or second side margin portion coming in contact with a distal end of an internal electrode disposed in an outermost portion of the ceramic body to a thickness of a region of the first or second side margin portion coming in contact with a distal end of an internal electrode disposed in a central portion of the ceramic body among the plurality of internal electrodes is 0.9 or more to 1.0 or less,
each of the first side margin portion and the second side margin portion includes only one layer, and
each of the plurality of internal electrodes is composed of a same material extending from the first side margin portion to the second side margin portion.

2. (canceled)

3. The multilayer ceramic capacitor of claim 1, wherein a ratio of a thickness of a region of the first or second side margin portion coming in contact with a corner of the ceramic body to the thickness of the region of the first or second side margin portion coming in contact with the distal end of the internal electrode disposed in the central portion of the ceramic body among the plurality of internal electrodes is 0.9 or more to 1.0 or less.

4. The multilayer ceramic capacitor of claim 1, wherein a thickness of the dielectric layer is 0.4 μm or less and a thickness of the internal electrode is 0.4 μm or less.

5. The multilayer ceramic capacitor of claim 1, wherein the first side margin portion is disposed so as not to exceed points at which the third surface of the ceramic body intersects the fifth and sixth surfaces thereof, respectively, and the second side margin portion is disposed so as not to exceed points at which the fourth surface of the ceramic body intersects the fifth and sixth surfaces thereof, respectively.

6. The multilayer ceramic capacitor of claim 1, wherein the first side margin portion does not extend above the fifth and sixth surfaces of the ceramic body, and the second side margin portion does not extend above the fifth and sixth surfaces of the ceramic body.

7. A method of manufacturing a multilayer ceramic capacitor, the method comprising:
preparing a first ceramic green sheet on which a plurality of first internal electrode patterns are formed with a predetermined interval therebetween and a second ceramic green sheet on which a plurality of second internal electrode patterns are formed with a predetermined interval therebetween;
forming a ceramic green sheet laminate by stacking the first and second ceramic green sheets so that the first and second internal electrode patterns are alternated with each other;
cutting the ceramic green sheet laminate to have side surfaces to which distal ends of the first and second internal electrode patterns are exposed in a width direction;
forming first and second side margin portions on the side surfaces of the cut ceramic green sheet laminate to which the distal ends of the first and second internal electrode patterns are exposed;
sintering the ceramic green sheet laminate with the first and second side margin portions to form a ceramic body, the ceramic body having first and second surfaces on which the first and second side margin portions are respectively disposed, third and fourth surfaces from which respective ends of the first and second internal electrode patterns are alternatively exposed, and fifth and sixth surfaces connected to the first to the fourth surfaces, respectively;
forming a first external electrode on the third surface of the ceramic body and covering respective first portions of the first, second, fifth, and sixth surfaces; and
forming a second external electrode disposed on the fourth surface of the ceramic body and covering respective second portions of the first, second, fifth, and sixth surfaces, wherein an average thickness of each of the first and second side margin portions is 2 μm or more to 10 μm or less,
a ratio of a thickness of a region of the first or second side margin portion coming in contact with a distal end of an internal electrode pattern disposed in an outermost portion of the ceramic body to a thickness of a region of the first or second side margin portion coming in contact with a distal end of an internal electrode pattern disposed in a central portion of the ceramic body among the plurality of first and second internal electrode patterns is 0.9 or more to 1.0 or less,
each of the first side margin portion and the second side margin portion includes only one layer, and
each of the first and second internal electrode patterns is composed of a same material extending from the first side margin portion to the second side margin portion.

8. The method of claim 7, wherein a thickness of the first and second ceramic green sheets is 0.6 μm or less, and a thickness of the first and second internal electrode patterns is 0.5 μm or less.

9. (canceled)

10. The method of claim 7, wherein a ratio of a region of the first or second side margin portion coming in contact with a corner of the ceramic body to the thickness of the region of the first or second side margin portion coming in contact with the distal end of the internal electrode pattern disposed in the central portion of the ceramic body among the plurality of first and second internal electrode patterns is 0.9 or more to 1.0 or less.

11. (canceled)

12. The method of claim 7, wherein the first side margin portion has a slope with respect to the fifth surface or the sixth surface having the same sign at corner portions at which the first surface of the ceramic body and the fifth and sixth surfaces thereof intersect each other, and the second side margin portion has a slope with respect to the fifth surface or the sixth surface having the same sign at corner portions at which the second surface of the ceramic body and the fifth and sixth surfaces thereof intersect each other.

13. The method of claim 7, wherein the first side margin portion is disposed so as not to exceed points at which the third surface of the ceramic body intersects the fifth and sixth surfaces thereof, respectively, and the second side margin portion is disposed so as not to exceed points at which the fourth surface of the ceramic body intersects the fifth and sixth surfaces thereof, respectively.

14. The method of claim 11, wherein the first side margin portion does not extend above the fifth and sixth surfaces of the ceramic body, and the second side margin portion does not extend above the fifth and sixth surfaces of the ceramic body.

15. The method of claim 7, wherein the first side margin portion is formed by pressing one of the side surfaces of the cut ceramic green sheet laminate into a first ceramic green sheet so as to transfer a portion of the first ceramic green sheet as the first side margin portion on the one of the side surfaces of the cut ceramic green sheet laminate, and
the second side margin portion is formed by pressing another of the side surfaces of the cut ceramic green sheet laminate into a second ceramic green sheet so as to transfer a portion of the second ceramic green sheet as the second side margin portion on the another of the side surfaces of the cut ceramic green sheet laminate.

16. The method of claim 7, wherein corner portions of the first and second side margins having a curved surface are spaced apart from an outermost one of the first and second internal electrode patterns in the ceramic body.

17. The method of claim 7, wherein each of the first and second internal electrode patterns extends continuously between the first and second margin portions.

18. The multilayer ceramic capacitor of claim 1, wherein the corner portions having a curved surface are spaced apart from an outermost one of the plurality of internal electrodes in the ceramic body.

19. The multilayer ceramic capacitor of claim 1, wherein each of the plurality of internal electrodes extends continuously between the first and second margin portions.
